(19) United States
(12) Patent Application Publication
(10) Pub. No.: US 2010/0082432 A1
(43) Pub. Date: Apr. 1, 2010

(54) SYSTEMS AND METHODS FOR PROVIDING CONSTRAINT-BASED ADVERTISING

(75) Inventors: Andrew An Feng, Cupertino, CA (US); Patrick Loo, Saratoga, CA (US); Rohit Chandra, Los Altos, CA (US); Ying-Fu Su, San Jose, CA (US); Stephen Carney, Mountain View, CA (US); Vikas Gupta, Pasadena, CA (US); Stephen Quan, Los Altos, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/241,478

(22) Filed: Sep. 30, 2008

(51) Int. Cl. G06Q 30/00

(52) U.S. Cl. 705/14.53

(57) ABSTRACT

The present invention is directed towards systems and methods for providing up-to-date constraint based advertising content. The method according to one embodiment of the present invention comprises receiving a request for advertisement content and selecting a first plurality of advertisements meeting the user profile data. The method then filters the first plurality of advertisements based on advertiser and publisher constraints and selecting a second plurality of advertisements and provides the second plurality of advertisements to a user.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

Embodiments of the invention described herein generally relate to providing up-to-date constraint based advertising content. More specifically, embodiments of the present invention are directed towards systems and methods for receiving up-to-date constraints from a plurality of advertisers and publishers, as well as filtering advertisements based on up-to-date constraints.

### BACKGROUND OF THE INVENTION

Since the widespread acceptance of the Internet, advertising as a main source of revenue has proven to be both effective and lucrative. Advertising on the Internet provides the additional benefit of allowing advertisers to more effectively target audiences viewing their advertisements as opposed to traditional print and “hard copy” advertising which constitute a one-way flow of information: advertisers to users.

The very nature of the Internet facilitates at two way flow of information between users and advertisers and allows these transactions to be conducted in real time or near-to-real time. For example, a user may request an ad and may intentionally, or inherently, transmit various pieces of data describing him or her. Additionally, an advertising management system may be able to intelligently determine which ads to place on a given website requesting advertisement content, increasing the revenue for both parties involved and increasing user satisfaction by eliminating “nuisance” ads, or those ads in which a user is not interested.

The current state of the art, however, fails to fully exploit the interactive aspects of the Internet in the advertising realm. Thus, there currently exists a need in the art for providing a system that allows advertisers, content publishers and users to interact in real-time to determine the content of advertisements. The present invention cures these deficiencies by providing systems and methods for allowing publishers and advertisers to modify and propagate one or more advertisement preferences in real time.

### SUMMARY OF THE INVENTION

The present invention is directed towards systems and methods for providing up-to-date constraint based advertising content. The method of the present invention comprises receiving a request for advertisement content. In one embodiment, an advertiser slot located on a publisher webpage generates a request for advertisement content.

The method then filters advertisements based on user profile data and selects a first plurality of advertisements meeting the user profile data. In a first embodiment, user profile data may comprise user demographic information including user age, location, income or interests. In a first embodiment, user demographic information may be stored within a user profile for storage on one or more servers. In an alternative embodiment, user demographic information may be stored within a client-side cookie.

The method then filters the first plurality of advertisements based on advertiser and publisher constraints and selects a second plurality of advertisements. In one embodiment, advertiser and publisher constraints may be updated in real time by advertisers and publishers. Furthermore, the second plurality of advertisements may comprise textual, video, or graphical advertisements. In a first embodiment, the method further comprises indexing advertiser data in real time and indexing advertiser data offline. The method then finally provides the second plurality of advertisements to a user.

The system of the present invention comprises a plurality of client devices operative to transmit requests for advertising content wherein a request for advertisement content may be generated by an advertiser slot located on a publisher website. The system further comprises a user data server operative to generate a plurality of user profile data. In one embodiment, user profile data may comprise user demographic information including user age, location, income or interests. In a first embodiment, user demographic information may be stored within a user profile for storage on one or more server. In an alternative embodiment, user demographic information may be stored within a client-side cookie.

The system further comprises an ad retrieval server operative to filter a plurality of advertisements based on user profile data and selecting a first plurality of advertisements meeting the user profile data and a front end rule server operative to filter the first plurality of advertisements based on advertiser and publisher constraints and selecting a second plurality of advertisements. In one embodiment, advertiser and publisher constraints are updated in real time by advertisers and publishers. Furthermore, the second plurality of advertisements may comprise textual, video, or graphical advertisements.

In alternative embodiment, the system may comprise a real-time indexer operative to index advertiser data in real time and an offline indexer operative to index advertiser data offline. The system additionally comprises a content server operative to received requests for advertising content and provide the second plurality of advertisements to a user.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for providing up-to-date constraint based advertising content according to one embodiment of the present invention;

FIG. 2 presents a flow diagram illustrating a method for retrieving a plurality of up-to-date advertisements in response to a user request according to one embodiment of the present invention;

FIG. 3 presents a flow diagram illustrating a method for filtering and ranking a plurality of advertisements according to one embodiment of the present invention;

FIG. 4 presents a flow diagram illustrating a method for retrieving one or more up-to-date constraints for application to an advertisement request according to one embodiment of the present invention; and

FIG. 5 presents a swim lane diagram illustrating a method for retrieving a plurality of up-to-date advertisements according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

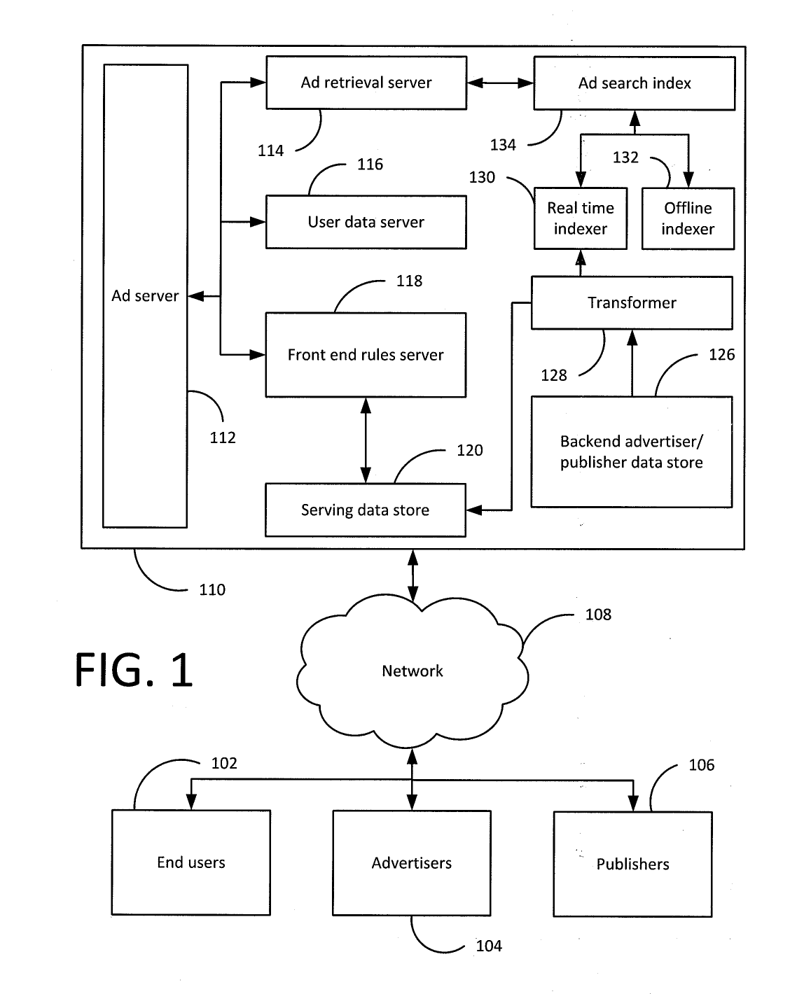

FIG. 1 presents a block diagram depicting a system for providing up-to-date constraint based advertising content according to one embodiment of the present invention. According to the embodiment that FIG. 1 illustrates, a plurality of end users 102, advertisers 104 and publishers 106 are coupled to a network 108. In the illustrated embodiment, end users 102, advertisers 104 and publishers 106 may comprise general purpose computing devices having a central processing unit, memory unit, permanent storage, optical drive(s), universal serial bus port(s), audio/video output devices, network interfaces, etc.

The system 100 further includes an ad content provider 110 coupled to network 108 and in communication with end users 102, advertisers 104 and publishers 106. Content provider 110 includes an ad server 112 operative to handle requests from end users 102 and transmit data to end users 102. In the illustrated embodiment, ad server 112 handles requests for advertisements from end users 102. For example, an end user 102 may first request a page of content from publisher 106. The publisher 106 may, in turn, return a content page to the end user 102, the content page containing a link to a request for an advertisement from a content provider 110.

Content provider 110 include an ad server 112 operative to receive requests for advertisements from client and return ads to a end user 102. In the illustrated embodiment, ad server 112 may comprise a plurality of hardware and software components, as known in the art. Additionally, content provider 110 may contain a backend advertiser/publisher data store 126. The backend advertiser/publisher data store 126 according to one embodiment is updated by advertisers and publishers, respectively.

In one embodiment, backend advertiser/publisher data store 126 may be operative to receiving advertising data from a plurality of advertisers 104. In one embodiment, advertising data may comprise text, graphic or video data (herein referred to as “creative data”) related to a given advertisement. Additionally, advertiser data may comprise metadata or rules associated with a given set of creative data. For example, for a given advertisement an advertiser 104 may transmit a graphical banner ad as well as text associated with the banner ad (e.g., a caption or similar form of text). Additionally, the advertiser 102 may transmit metadata associated with the banner ad including, but not limited to, keywords associated with the advertisement, and a time period to display the advertisement. Advertiser data transmitted to content provider 110 may comprise one or more constraints or rules determine when/where advertisements should/could be displayed. For example, a given advertiser may give a “blacklist” of sites at which to not display advertisements and a “whitelist” of sites to always display ads, a whitelist indicating ranking preferences of sites designated for an advertiser's advertisement.

In one embodiment, backend advertiser/publisher data store 126 may be operative to receive publisher data from a plurality of publishers 106. As previously discussed, publisher 106 may comprise a website provider who subscribes to an advertising service; that is, publisher 106 may desire to place advertisements on his or her website and may negotiate an advertising agreement with content provider 110 to provide the advertisements. Publisher data transmitted to content provider 110 may comprise a plurality of constraints or rules determine what advertisements are displayed on pages of a publisher's website. For example, a given publisher may specify a plurality of terms he or she does not want an advertisement to contain (e.g., offensive content) or he or she may specify a plurality of advertisers he or she does not want to advertise on his or her site. In one embodiment, backend advertiser/publisher data store 126 may comprise a bulk storage device operative to store raw formatted rules and constraints submitted by advertisers and publishers as well as creative data submitted by advertisers.

Transformer 128 is communicatively coupled to advertiser/publisher data store 126 and may be operative to transform data stored within advertiser/publisher data store 126 to a more suitable format as determined by the system 100. In one embodiment, transformer 128 may be operative to “clean” incoming data to minimize or eliminate data anomalies and re-format data into a format usable by system 100. A suitable format may comprise any format having uniform characteristics across the received data. In one embodiment, the chosen suitable format may be a format that optimizes the overall performance of the system 100.

In addition to the foregoing, transformer 128 is communicatively coupled to real-time indexer 130, offline indexer 132 and serving data store 120. In the illustrated embodiment, real-time indexer 130 is operative to retrieve advertisement data from advertiser/publisher data store 126 and index incoming advertisements in real-time or near real-time. Real-time indexer 130 may be operative to store an index related to a given advertisement within ad search index 134. Indexing data for subsequent retrieval is well known in the art and is not discussed further for the sake of clarity. It should be noted that real-time indexer 130 may be operative to perform a high level index of a given creative. In one embodiment, a high level index may comprise indexing explicit features of the creative. For example, keywords associated with the advertisement and supplied by an advertiser may be utilized to index an incoming creative.

In addition to indexing performed by real-time indexer 130, offline indexer 132 may be operative to perform a more thorough indexing of creative content. In one embodiment, offline indexer 132 may perform batch indexing of creative data at predetermined intervals. For example, offline indexer 132 may be operative to re-index data indexed by real-time indexer 130 more thoroughly than originally indexed. Real-time indexer 130 and offline indexer 132 are communicatively coupled to ad search index 134 and may be operative to store indexing results for received data. Ad search index 134 may comprise any search index known in the art such as an inverted index, n-gram index or forward index.

Transformer 128 may further be coupled to serving data store 120, operative to store rules related to serving advertising content. In one embodiment, serving data store 120 is operative to store a plurality of rules associating advertisements with advertisers and advertisements to publishers. Serving data store 120 may comprise a storage device such as a relational database storing the relationship between rules and advertisements in the form of identifying keys. Data stored within data store 120 may be accessed by front end rules server 118, as is described in further detail below.

The system 100 contains an ad server 112 operative to receive requests for advertisements from a plurality of end users 102. In one embodiment, a request for advertisements may comprise an HTTP request for advertising content initiated by a web page provided by publishers 106 to end users 102. In the illustrated embodiment, a request for advertisements may contain various request parameters such as web page information, user information (e.g., contained in a user cookie or collected dynamically) or device information. For example, a request for advertisement may specify that the requesting webpage is directed towards “snowmobiles”, located on the domain “example.com”, that the user is a male between the ages 18 and 25, that the user is located in Ottawa, Canada and that the user's screen resolution is 800 by 600 pixels.

In the illustrated embodiment, ad server 112 is communicatively coupled to user data server 116. User data server 116 is operative to generate a plurality of user-based constraints for a given ad request. For example, a request for advertisements may contain user profile identification such as a user ID. Ad server 112 may be operative to transmit the user ID to user data server 116 which, in turn, may be operative to retrieve a user profile containing detailed information regarding the requesting user. From this detailed data (e.g., age, gender, income, etc), user data server 116 may be operative to formulate rules specific to the user (e.g., if a user is under 16, filter out advertisements for R rated movies). In one embodiment, user data server 116 acts as a “first” filter for filtering a generic set of advertisements as is described in greater detail below.

After generating a plurality of user profiles, ad server 112 may transmit the request for advertisements as well as the plurality of user profiles to ad retrieval server 114. In the illustrated embodiment, ad retrieval server 114 is operative to query ad index 134 and return a plurality of advertisements from an ad storage module (not shown) related to the advertisement request. In one embodiment, ad retrieval server 114 may further be operative to filter advertisements based on rules received from ad server 112.

Ad retrieval server 114 returns a plurality of user-filtered advertisements to ad server 112 which, in turn, transmits the list of advertisements to front end rules server 118. Front end rules server 118 is operative to further advertisements based on publisher and advertiser constraints, which may be processed in real time. Data transmitted to front end rules server may comprise publisher information and a list of advertisements, a list of advertisements comprising advertisements terms and an advertiser ID associated with an advertisement.

In the illustrated embodiment, front end rules server 118 may extract publisher identifying information and query serving data store to retrieve constraints associated with a given publisher. For example, front end rules server 118 may query serving data store 120 and determine that a given publisher has blacklisted a plurality of advertisers from advertising on their website. In this example, front end rules server 118 may filter out one or more advertisements associated with blacklisted advertisers. In addition to retrieving publisher constraints, front end rules server 118 may be operative to retrieve advertiser constraints for advertisements retrieved from ad server 112. For a list of given advertisements, front end rules server 118 may be operative to associate advertiser rules with a given advertisement. For example, an advertiser may specify a specific date range that his or her advertisement should be displayed during. If front end rules server detects that the current date or time does not match this constraint, the advertisement may be dropped from the advertisement list.

The front end rule server 118 is further operative to return a final listing of filtered advertisements to ad server 112. Ad server 112 may then be able to further refine the advertisement using non-rule based filtering. For example, ad server 112 may rank advertisements by bid price and select the most lucrative advertisements returned by front end rule server 118. In an alternative embodiment, ad server 112 may also be operative to select the number of ads to return based on the number of available advertisement slots located on the requested publisher web page.

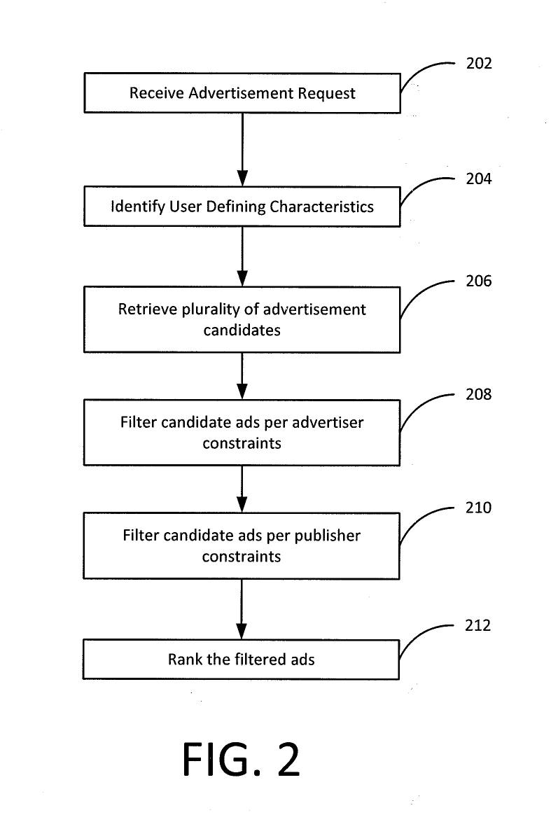

FIG. 2 presents a flow diagram illustrating a method for retrieving a plurality of up-to-date advertisements in response to a user request according to one embodiment of the present invention. As illustrated, the method 200 receives an advertisement request, step 202. In one embodiment, a request for an advertisement may comprise an HTTP request for advertising data generated by a web page provided by a publisher. For example, a user may request a publisher's web page which in turn generates a request for advertisement data for placement on the webpage. Advertisement data may comprise audio, video, graphical or textual data.

The method 200 then identifies user defining characteristics associated with the request, step 204. In one embodiment, user defining characteristics may comprise information related to the user initiating a request for advertisements. User defining characteristics may include geographical data determined from an IP address, user information stored within a client-side cookie or user profile data associated with a user. For example, a user requesting an advertisement may create a user profile including information such as age, gender, income, interests, hobbies, etc.

The method 200 then retrieves a plurality of advertisement candidates, step 206. User characteristics retrieved in step 204 may be utilized as one method of filtering a large corpus of advertisements. For example, the method 200 may determine that advertisements for an upcoming video game may not be suitable for older user, or conversely, that advertisements for mortgages may not be suitable for teenage users.

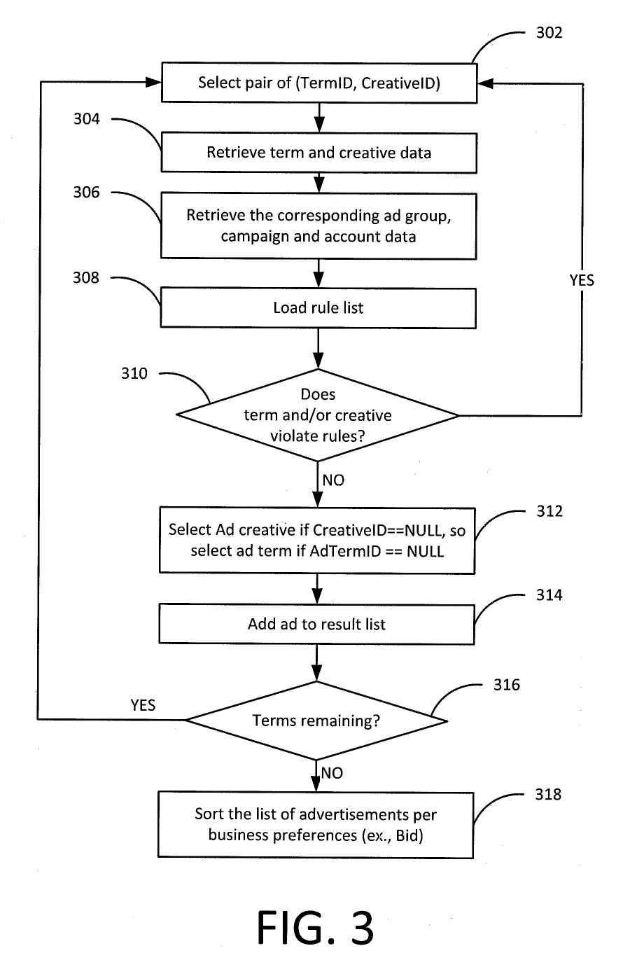

The method 200 filters candidate ads per advertiser constraints, step 208. In one embodiment, advertising constraints may comprise rules imposed by advertisers of content. For example, an advertiser may specify that a given advertisement not be displayed on a plurality of pages (i.e., a “blacklist”) or that an advertisement not be displayed during a predetermined time interval (e.g., between the hours of 11 PM and 6 AM). In the illustrated embodiment, filtering candidate ads per advertiser constraints may comprise retrieving up-to-date constraints submitted by advertisers in real-time. In another embodiment, constraints may correspond to a plurality of constraints formatted to a normalized constraint format. In one embodiment, filtering advertisements may comprise removing a plurality of advertisements not meeting advertising constraints retrieved in step 208. One method for filtering advertisements is discussed in further detail with respect to FIG. 3.

The method 200 then filters candidate ads per publisher constraints, step 210. In one embodiment, publisher constraints may comprise rules imposed by publishers of content. For example, a publisher may specify that advertisements containing a plurality of forbidden terms not be displayed. In the illustrated embodiment, filtering candidate ads per publisher constraints may comprise retrieving up-to-date constraints submitted by publishers in real-time. In another embodiment, constraints may correspond to a plurality of constraints formatted to a normalized constraint format. In one embodiment, filtering advertisements may comprise removing a plurality of advertisements not meeting publisher constraints.

Although the method 200 illustrates only advertiser and publisher constraints, a plurality of other constraints may be utilized by the method 200 to filter advertisements according to method 200. For example, in one embodiment the method 200 may further be operative to filter candidate ads based on legal constraints. In this embodiment, the method 200 may filter advertisements based on regional legal constraints. For example, if a user requesting an advertisement is determined to be under the age of 18 and located within the United States, the method 200 may retrieve legal constraints that filter advertisements for tobacco products.

In one embodiment, the method 200 may be operative to retrieve advertiser constraints in real time. In this embodiment, advertisers and publishers may be able to modify existing constraints, add new constraints or delete existing constraints. The method 200 is operative to utilize these constraints as they are updated by advertisers and publishers. In alternative embodiment, constraints may be updated automatically (e.g., time based constraints) without the intervention of an advertiser or publisher. In one embodiment, the method 200 may provide a user interface allowing advertisers and publishers to visually see their existing constraints as well as add, delete or update the constraints. Additionally, the method 200 may be able to display constraint statistics (e.g., how many constraints were applied) in real-time, that is, as the constraints are applied to advertisement candidates.

Finally, the method 200 ranks and returns the filtered ads, step 212. Returning a plurality of advertisements may comprise selecting a plurality of advertisements based on requirements transmitted in a request for advertisements. For example, a given webpage may contain a plurality of advertisement slots such as a top banner slot and a side billboard slot. In this example, the method 200 may return the top two advertisements meeting the publisher slot constraints. Ranking advertisements may comprise sort advertisements by their relevancy to the page content. In an alternative embodiment, ranking may comprise sorting advertisements by bid price.

FIG. 3 presents a flow diagram illustrating a method for filtering and ranking a plurality of advertisements according to one embodiment of the present invention. As illustrated, the method 300 selects a term/creative pair, step 302. In the illustrated embodiment, a term may comprise textual data associated with a given advertisement. For example, a given advertisement for a digital camera may comprise the terms “camera”, “film”, “photography”, etc.

The method 300 retrieves term data, campaign data, ad group, campaign and account data for the selected term, steps 304 and 306, respectively. In one embodiment ad group data may include data related to a logical grouping of advertisements. For example, a single advertiser may define an ad group for a plurality of ads (e.g., a homogenous array of advertisements) and the method 300 may perform a plurality of checks against a given ad group associated with the advertisement such as checking if the ad group is active. In one embodiment, campaign data may comprise information related to the length of advertisement campaign (e.g., start and end dates). In one embodiment, account data may comprise information related to the account holder of the advertisement (e.g., advertiser name, address, billing information, etc).

For the selected term and/or creative, the method 300 loads a rule list, step 308. In one embodiment, a rule list may comprise one or more rules associated with an advertiser and/or publisher. For example, a publisher rule may indicate that one or more advertisers have been blacklisted from advertising on a website of the publisher. In this example, the method 300 may filter out one or more advertisements associated with blacklisted advertisers. Additionally, an advertiser rule may comprise a specific date range that his or her advertisement should be displayed during. The method 300 compares the selected term against the one or more retrieved rules, step 310. If the method 300 determines that a selected term violates a rule in the rule list, the method 300 selects the next term in the term list and repeats steps 303, 306, 308 and 310 for the next term.

If the method 300 determines that the given term and/or creative do not violate the publisher or advertiser rules, the advertisement is added to a result list, step 314. If no creative was given as input, an ad creative is selected for the given term, step 312. Similarly, if no terms were given as input, an at term is selected for the given term, step 312. The method 300 then repeats steps 303, 306, 308, 310, 312, 314 and 316 for the remaining terms. After the final term has been inspected, the method 300 sorts the advertisements determined to be in accordance with publisher and advertiser constraints according to the bid price associated with the advertisements, step 318. In alternative embodiments, various other criteria may be used to sort the final result set of advertisements, such as relevancy or other metrics know to those of skill in the art.

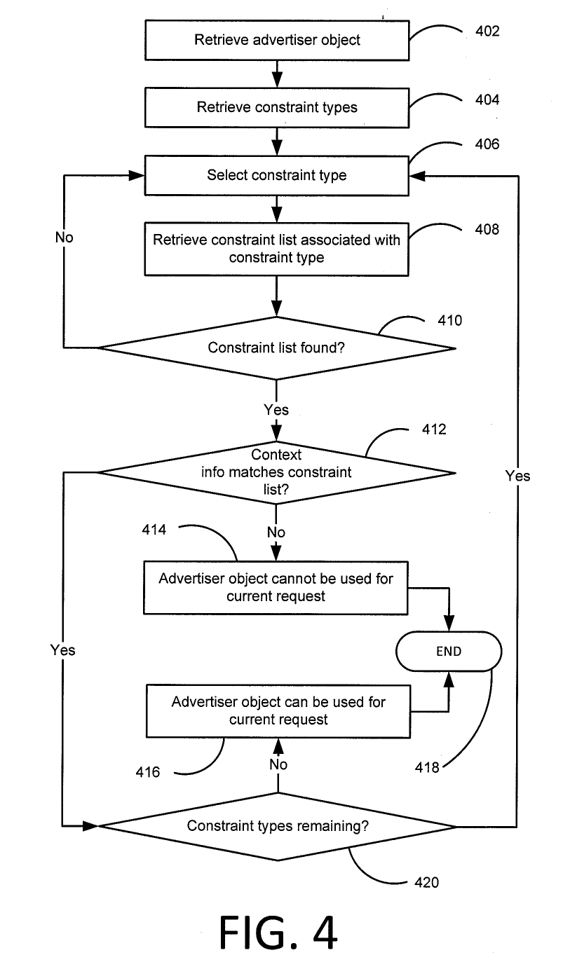

FIG. 4 presents a flow diagram illustrating a method for retrieving one or more up-to-date constraints for application to an advertisement request according to one embodiment of the present invention. As illustrated, the method 400 retrieves an advertiser object, step 402, which may include data related to an advertiser account, campaign or ad group.

The method 400 receives one or more constraint types associated with a given advertiser object, step 404. In one embodiment, constraint types may comprise various constraint categories to allow filtering in accordance with various metrics. For example, a set of constraint types may comprise location constraints, page based constraints or time based constraints that may indicate to whom advertisements may be displayed, on what pages advertisement may be displayed or when advertisements may be displayed, respectively.

The method 400 selects a given constraint type, step 406 and retrieves a constraint list associated with the constraint type, step 408. In one embodiment, a constraint list may comprise one or more categorical constraints corresponding to the selected constraint type. For example, a location constraint type may comprise one or more constraints indicating in what countries advertisements should not be displayed. If a constraint list is not found, step 410, a next constraint type is selected, step 406

If a constraint list is found, step 410, the method 400 may determine if context info for the request matches the constraint list, step 412. In one embodiment, this may comprise comparing page contextual data with contextual data associated with a constraint. A given constraint may be expressed as one of multiple types, which according to one embodiment takes the form of a positive constraint or a negative constraint. For example, a positive constraint may express a constraint “inclusively,” such as “include all users from the US and Canada,” or “exclusively,” such as “do not include any users from Mexico.” If it is determined that the constraint list does not match the contextual data, step 412, the method 400 may indicate that the advertiser object could not be used for a current request, step 414, causing the process to conclude, step 418.

If the check at step 412 evaluates to true, indicating that the constraint list matches the contextual data, the method 400 determines whether or not additional constraint types are remaining that require inspection, step 420. If additional constraints are present, program flow returns to step 406 for processing of any remaining constraint types. Where no additional constraint types exist, step 420, the method 400 may indicate that the advertiser object can be used for the current request, step 416, causing the process to conclude, step 418.

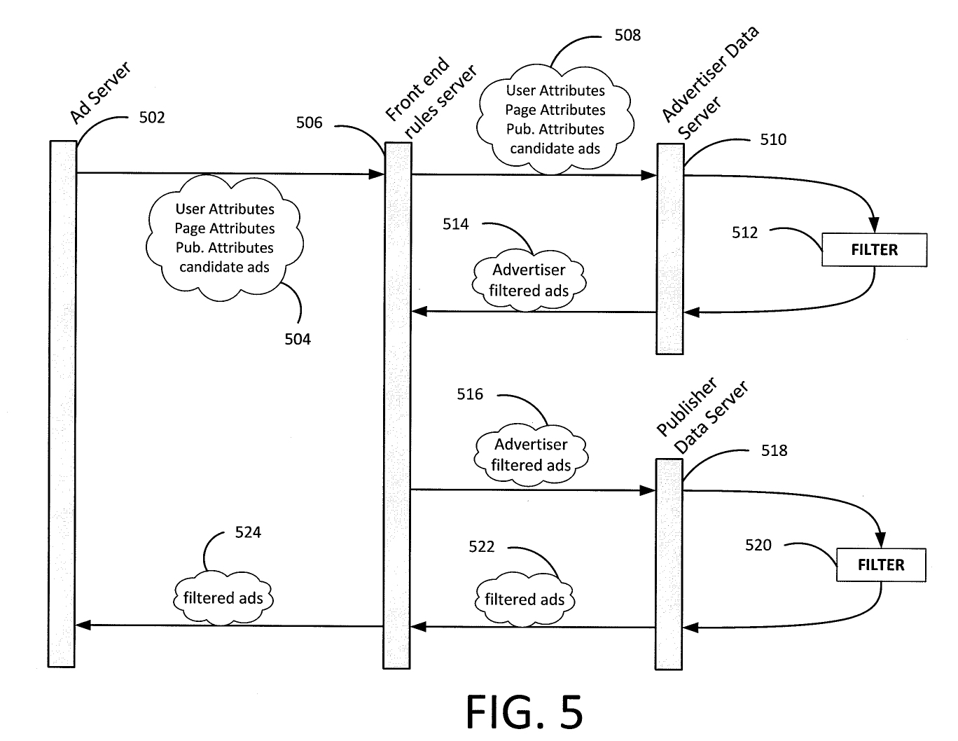

FIG. 5 presents a swim lane diagram illustrating a method for retrieving a plurality of up-to-date advertisements according to one embodiment of the present invention. As illustrated, an ad server 502 submits a plurality of attributes 504 (e.g., user, page, publisher attributes and candidate ads) to a front end rules server 506. Front end rules server 506 may include a device operative to manage transactions during the generation of an ad set.

Front end rules server 506 is operative to forward a set of attributes 508 to an account data store 510 which filters 512 a plurality of advertisements (not shown) against the received attributes 508 and returns a set of advertiser filtered ads 514. In one embodiment, account data store 510 may comprise a computing device operative to query an advertisement server and retrieve a plurality of advertisements associated with a first set of constraints. As previously described, a first plurality of constraints may comprise constraints related to a user requesting advertisements.

In the illustrated embodiment, advertiser filtered ads 514 may comprise a plurality of advertisements that meet constraints contained or extracted from attributes 508. As previously described, account data store 510 may be operative to filter 512 the returned advertisements by a plurality of advertiser constraints such as campaign dates, publisher blacklist etc.

Front end rules server 506 receives advertiser filtered ads 514 and forwards the advertiser filtered ads 516 to publisher data store 518. As previously described, publisher data store 518 may be operative to inspect the advertiser filtered ads 516 and filter 520 the advertiser filtered ads 516 according to a plurality of predetermined publisher constraints such as advertiser black listings, keyword exemptions etc. The publisher data store 518 transmits the filtered ads 522 to front end rules server 506, which, in turn, forwards the filtered ads 524 to client 502.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for providing up-to-date constraint based advertising content, the method comprising:
receiving a request for advertisement content;
selecting a first plurality of advertisements that satisfy user profile data;
generating a list of candidate advertisements from the first plurality of selected advertisements based on user profile data and request context;
filtering list of candidate advertisements based on advertiser and publisher constraints to select a second plurality of advertisements; and
providing the second plurality of advertisements to a user.

2. The method of claim 1 comprising generating a request for advertising content by an advertiser slot located on a publisher webpage.

3. The method of claim 1 wherein selecting a first plurality of advertisements comprises selecting based on user demographic information.

4. The method of claim 3 selecting based on user demographic information comprises selecting based on user age, location, income or interests.

5. The method of claim 3 comprising storing the user demographic information within a user profile.

6. The method of claim 3 comprising storing the user demographic information within a client-side cookie.

7. The method of claim 1 comprising updating the advertiser and publisher constraints in real time by advertisers and publishers.

8. The method of claim 1 wherein providing the second plurality of advertisements comprises providing textual, video, or graphical advertisements.

9. The method of claim 1 further comprising indexing advertiser data in real time.

10. The method of claim 9 comprising indexing advertiser data offline.

11. A system for providing up-to-date constraint based advertising content, the system comprising:
a plurality of client devices operative to transmit requests for advertising content;
a user data server operative to generate a plurality of user profile data;
an ad retrieval server operative to filter a plurality of advertisements based on user profile data and selecting a first plurality of advertisements meeting the user profile data;
a front end rule server operative to filter the first plurality of advertisements based on advertiser and publisher constraints and selecting a second plurality of advertisements; and
a content server operative to received requests for advertising content and provide the second plurality of advertisements to a user;

12. The system of claim 11 wherein an advertiser slot located on a publisher webpage generates a request for advertisement content.

13. The system of claim 11 wherein user profile data comprise user demographic information.

14. The system of claim 13 wherein user demographic information includes user age, location, income or interests.

15. The system of claim 13 wherein the user demographic information is stored within a user profile.

16. The system of claim 13 wherein the user demographic information is stored within a client-side cookie.

17. The system of claim 11 wherein the advertiser and publisher constraints are updated in real time by advertisers and publishers.

18. The system of claim 11 wherein the second plurality of advertisements comprises textual, video, or graphical advertisements.

19. The system of claim 11 further comprising a real-time indexer operative to index advertiser data in real time.

20. The system of claim 11 further comprising an offline indexer operative to index advertiser data offline.

21. Computer readable media comprising program code that when executed by a programmable processor causes the programmable processor to execute a method for providing up-to-date constraint based advertising content, the computer readable media comprising:
program code for receiving a request for advertisement content;
program code for selecting a first plurality of advertisements that satisfy user profile data;
program code for generating a list of candidate advertisements from the first plurality of selected advertisements based on user profile data and request context;
program code for filtering list of candidate advertisements based on advertiser and publisher constraints to select a second plurality of advertisements; and
program code for providing the second plurality of advertisements to a user.

22. The computer readable media of claim 21 comprising program code for generating a request for advertising content by an advertiser slot located on a publisher webpage.

23. The computer readable media of claim 21 wherein program code for selecting a first plurality of advertisements comprises program code for selecting based on user demographic information.

24. The computer readable media of claim 23 wherein program code for selecting based on user demographic information comprises program code for selecting based on user age, location, income or interests.

25. The computer readable media of claim 23 comprising program code for storing the user demographic information within a user profile.

26. The computer readable media of claim 23 comprising program code for storing the user demographic information within a client-side cookie.

27. The computer readable media of claim 21 comprising program code for updating the advertiser and publisher constraints in real time by advertisers and publishers.

28. The computer readable media of claim 21 wherein program code for providing the second plurality of advertisements program code for comprises providing textual, video, or graphical advertisements.

29. The computer readable media of claim 21 comprising program code for indexing advertiser data in real time.

30. The computer readable media of claim 29 comprising program code for indexing advertiser data offline.
